(19) United States
(12) Patent Application Publication
(10) Pub. No.: US 2009/0079697 A1
(43) Pub. Date: Mar. 26, 2009

(54) MODULAR KEYPAD MECHANISM

(75) Inventor: Shuli Shmaya, Petah Tiqwa (IL)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/160,808

(22) PCT Filed: Dec. 29, 2006
(86) PCT No.: PCT/US06/62692

§ 371 Date: Jul. 14, 2008

(30) Foreign Application Priority Data
Jan. 24, 2006 (GB) 0601385.8

(51) Int. Cl. G06F 3/02

(52) U.S. Cl. 345/169

(57) ABSTRACT

A Hand Held Computing device (HHC) (180) incorporating a keypad function (120), a display function (100) and processing function (430), the processing function (430) being operably coupled to both the keypad (120) and display (100) functions. The keypad function (120) is of a modular construction, such that a removable key-holder (300) may be de-coupled from the device (180), rotated, and re-assembled to the device (180) in a different orientation (230, 210), the keypad function being operable in this new orientation.

### FIELD OF THE INVENTION

The present invention relates to a means for re-configuring a portable computing device, such that the device can be easily re-configured for use in a variety of operating modes. The invention is applicable to, but not limited to, improving the usability of a hand held computing device (HHC).

### BACKGROUND OF THE INVENTION

A group of portable computing devices, known as Hand Held Computers, have become popular in applications where it is necessary to record or process real-time information, e.g. data from a manufacturing process, data regarding a construction project recorded on-site, inventory data in a supermarket, etc. Often, only a person physically walking around and recording the data on a suitable HHC can efficiently obtain such information.

HHC devices typically comprise a display and a data entry mechanism, such as a keypad and/or touch screen. The device may be either held in the hand (hand-held) or “worn”, say by attaching it to the user's wrist or arm by means of some mechanical fastening mechanism. The advantage of wearing the device is that the user has instant access to it at all times, can still use both hands and doesn't have to take it in and out of his/her pocket, as (s)he would with a standard PDA HHC device.

It is naturally beneficial if the same device can be used in a variety of modes. Furthermore, it would be beneficial if such a device was useable for both right-handed and left-handed users.

Due to conflicting requirements of various operating modes, most devices are optimised for one specific mode of operation, and are at best merely useable in other modes. A hand-held PDA, for example, can only be “worn” with difficulty.

Attempts have been made to alleviate these problems in both software and hardware. Device software may, for example, allow a touch-screen display to be switched between portrait and landscape modes. However, such software can only be used when the display also supports a virtual keypad or other virtual, purely display-based input, and cannot be used with a mechanical keypad.

In an attempt to address this problem, some mobile phones utilise a mechanical “double-keypad” mechanism, whereby the user flips open the case to reveal a second, larger, keypad. This keypad is oriented at 90° to the first, thus allowing the device to be used rotated through 90°. The rectangular display detects the opening of the keypad, and switches automatically to landscape mode.

Both of these approaches have significant disadvantages. The software-only approach requires that the HHC device has a large, expensive, touch-screen in order to display a virtual keypad, and enough processing power to generate the virtual input/output (I/O) devices on the screen.

This approach cannot be used in conjunction with devices that require real keyboards or keypad-based data entry mechanisms.

The dual-keypad approach, on the other hand, requires two keypads, one for a portrait mode and one for a landscape mode. These keypads require extra backlighting, are not mechanically robust and support only two orientations.

The existing attempts at addressing the problem are clearly inflexible and of limited practical value in supporting multiple modes of operation.

Thus, a need exists for a mechanically robust mechanism that allows a HHC device to be re-configured for use in a variety of orientations and modes, such as hand-held or worn, whilst retaining a compact form-factor that minimises cost and alleviates one or more of the aforementioned problems associated with the prior-art.

### SUMMARY OF THE INVENTION

In accordance with a first aspect of the present invention, there is provided a device, as claimed in Claim 1.

In accordance with a second aspect of the present invention, there is provided a modular keypad mechanism for use in a hand-held device, as claimed in Claim 9.

Further aspects and advantageous features of the present invention are as described in the appended Claims.

### BRIEF DESCRIPTION OF THE DRAWINGS

Exemplary embodiments of the present invention will now be described, by way of example only, with reference to the accompanying drawings, in which:

FIG. 1 illustrates a simplified form of a hand-held computing (HHC) device adapted in accordance with an embodiment of the present invention;

FIG. 2 illustrates a simplified form of the HHC adapted in accordance with an embodiment of the present invention and shows both left (arm) and right (arm)wearable orientations;

FIG. 3 illustrates the main mechanical components of a modular keypad mechanism and a display device in accordance with an embodiment of the present invention;

FIG. 4 schematically illustrates the interaction and operation of the main operational components of a HHC device according to an embodiment of the present invention; and

FIG. 5 shows a side elevation of a HHC in section, illustrating schematically the mechanical structure of the device in accordance with an embodiment of the present invention.

### DESCRIPTION OF EMBODIMENTS OF THE INVENTION

One embodiment of the present invention will be described in terms of a hand-held computing (HHC) device. However, it will be appreciated that the inventive concept may be embodied in other portable devices, such as communications devices, gaming devices, Personal Digital Assistants (PDA's) etc.

It is also envisaged that the inventive concept of the present invention is not limited to portable devices, but is applicable to any device with a data entry mechanism, such as a data entry unit used in a security system, or in a control device mounted to a machine.

A Hand Held Computing device according to the teachings of the current invention incorporates at least a mechanical keypad function, a display function and a processing function, such as a central processing unit (CPU). The CPU is operably coupled to both the keypad and display functions. The keypad function is of a modular construction such that a removable key-holder may be de-coupled from the device, rotated, and re-assembled to the device in a different orientation. Once reassembled to the HHC, the keypad function is operable in this new orientation. In this way, the HHC may be easily and advantageously re-configured by the user for use in a specific orientation. Once configured, the keypad and the display are in the correct orientation for use, both with respect to the device and to each other.

In a further advantageous embodiment, the removable key-holder supports two orientations and can thus be removed from the HHC, rotated through 180°, and re-assembled. This provides the user with the option of setting up a wearable device for both left and right arm use. This optimised design allows for only two orientations of the removable key-holder, and thus allows the user to quickly and accurately re-configure the HHC.

In a yet further advantageous embodiment the removable key-holder can be removed from the HHC, rotated through 90°, 180° or 270° and re-assembled. This provides the user with the option of configuring the device as a “landscape” format wearable device, for both left and right arm use. The device may also be configured as a “portrait” format hand-held or worn device, thus allowing for improved flexibility.

In order to yet further simplify the re-configuration task, an automatic removable key-holder detection mechanism is provided. This mechanism allows the HHC to sense the orientation of the removable key-holder and check if the removable key-holder has been re-located. If the removable key-holder has been re-located, the mechanism re-configures the keypad detection software accordingly, such that the correct key presses are detected.

In a further advantageous embodiment, the keypad function is designed such that the HHC device should be powered-down before the removable key-holder may be removed from the HHC. This ensures that the CPU is powered down before each re-configuration event, and thus simplifies the design of the device software/firmware. Therefore in this embodiment, the HHC device's control software may be configured to only check the removable key-holder orientation during the device boot-process, and not during normal device operation.

Images displayed on the HHC's display are arranged to correspond correctly with the orientation of the removable key-holder. Thus, in a further advantageous embodiment, the CPU detects a re-configuration of the removable key-holder, determines its new orientation, and automatically re-configures the display to correspond to the new orientation. Thus, the display may be switched between left-hand and right-hand landscape modes, or between landscape and portrait modes, according to the orientation of the removable key-holder.

Advantageously, the HHC device is provided with one or more orientation sensors, located so as to detect the position of the removable key-holder. The removable key-holder is itself provided with one or more mechanical structures, which, when the removable key-holder is assembled to the device, is/are detected by one or more of the orientation sensors. The CPU monitors the output of each of these sensors and uses the information to automatically, and advantageously, determine the orientation of the removable key-holder.

The device is further enhanced by the advantageous incorporation of a mechanical locking mechanism, which is disengaged or released before the removable key-holder may be removed. This embodiment provides mechanical security, thereby ensuring that the removable key-holder does not simply fall off or become loose during operation of the device. In addition, it forces the user to go through a specific, deterministic, procedure in order to re-orientate the removable key-holder.

A modular keypad mechanism for use in a hand-held computing device (HHC) comprises at least a removable key-holder, a keypad printed circuit board (PCB), and a locking device.

The removable key-holder part may be provided with recesses, one or more of which is/are utilised by the locking mechanism to lock the removable key-holder in place during operation of the HHC device.

The key holder may be further provided with a mechanical structure or orientation boss, which, when the keypad mechanism is assembled, is detected by one or more orientation sensors located on the keypad PCB. This modular keypad mechanism may be advantageously utilised as a design feature of a HHC device; for example one that increases the flexibility of the device and improves its functionality. The mechanism may be optimised and modified as required for the specific HHC device and application.

In this manner, one or more of the aforementioned problems associated with constructing a HHC device are alleviated. In particular, the device may be re-configured for use in a variety of orientations and modes such as hand held or worn, whilst retaining a compact form-factor and minimising cost.

The teachings of the current invention are applicable to any type of HHC device, including for example, wireless communication devices, portable DVD players, and any such device with a data entry mechanism that would benefit from an ability to be reconfigured for use in multiple orientations.

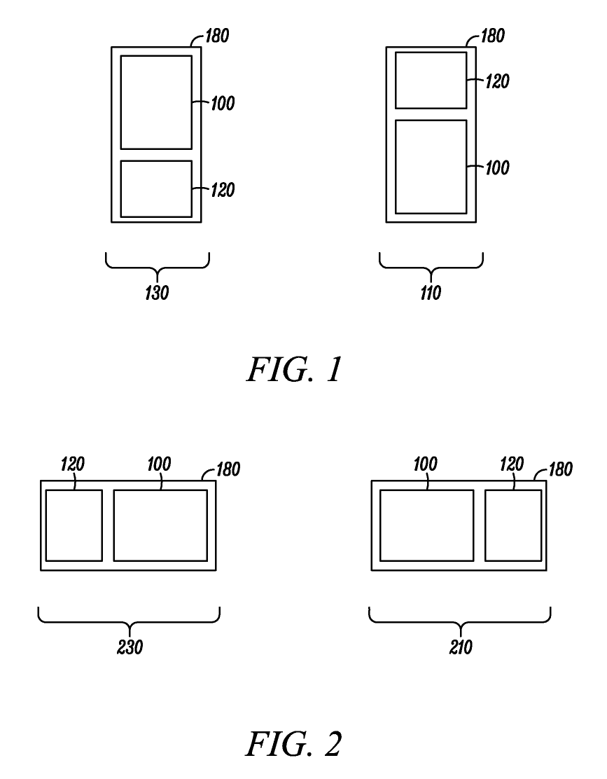

Referring now to FIG. 1, two simplified diagrams 130, 110 of a HHC device 180 according to an embodiment of the present invention are illustrated, the device being shown in two ‘portrait’ format orientations. The first orientation 130 shows the display 100 above the keypad 120, the second orientation 110 shows the display 100 below the keypad 120.

Thus, in FIG. 1, it can be seen that a device designed and optimised primarily for hand-held use (e.g. in a ‘portrait’ format 110, 130), typically has its display 100 located above its keypad 120. This prevents the view of the display 100 from being blocked by the users arm when using the keypad 120. If such a device is to be used effectively as a ‘worn’ device, then it has to be re-configured for ‘landscape’ mode 230, 210 as illustrated in FIG. 2. Such re-configuration of the device 180 is required in order to ensure that the orientation of the display 100 and keys in the keypad 120 are correct.

FIG. 2 shows the HHC device 180, in two ‘landscape’ format orientations 230, 210. In the first orientation 230 the keypad 120 is shown to the left of the display 100, whilst in the second orientation 210, the keypad 120 is shown to the right of the display 100. These views of the HHC device 180 are, in each case, simply the result of a rotation of the HHC device 180 from a given starting orientation 210, 230, through 180°.

In order to make these HHC devices 180 as user-friendly as possible, they usually incorporate a large graphical display 100 and a keypad data entry mechanism 120. The display 100 and keypad data entry mechanism 120 occupying a large proportion of the useable surface area of the device. The HCC device 180 may also support a touch-screen function, as well as having a keypad 120.

Depending upon the application, such devices 180 may be held in the hand, and used in ‘portrait’ orientation 110, 130 as shown in FIG. 1, or worn on the arm and used in ‘landscape’ orientation 230, 210, as shown in FIG. 2.

When used in a hand-held mode, the HHC device 180 is usually used in the vertical ‘portrait’ orientation 130, as it fits most conveniently in the hand in this orientation. However, when worn on the arm, the most obvious orientation is a ‘landscape’ mode 230, 210, as the device lies along, and is supported by, the users arm.

Thus, FIG. 1 and FIG. 2 illustrate different orientations of the HHC device once re-configured in accordance with embodiments of the present invention.

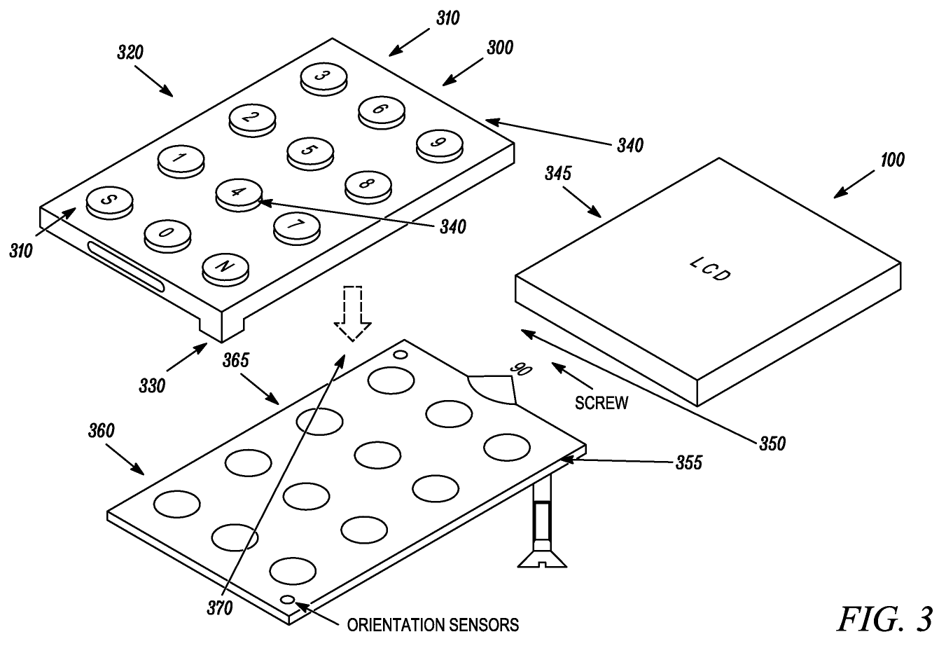

In one embodiment of the present invention, re-configuring the device comprises re-orientating the display 100 and the keypad 120 to correct for the 90° rotational transformation between a portrait-format 130 and a landscape-format 230. This device re-configuration is achieved by constructing the HHC device 180 as shown in FIG. 3, such that the keypad is of a modular construction, with a removable key-holder 300 in which the keys 320 are mounted, and a separate keypad-PCB 360 onto which the removable key-holder 320 is located.

In particular, FIG. 3 illustrates an exploded view of the device showing a removable key-holder 300, keypad-PCB 360 and display 100 (including lettering 345 indicating orientation of the display). The HHC device is shown in a landscape-format. In FIG. 3 it can be seen that the both the keys 320, and the alphanumeric characters 340 on the keys 320, must be correctly oriented with respect to the user, such that they are readable. Thus, both keys 320, and alphanumeric characters 340, must be correctly oriented with respect to both the display 100 and to the user.

In one embodiment of the present invention, a processing unit of the device (not shown) is made aware of the correct orientation of the removable key-holder 300, in order to prevent false operation of the device.

Furthermore, the modular keypad system in FIG. 3 comprises a locking mechanism, which is disengaged before the removable key-holder 300 may be removed from the HHC device.

In one embodiment, the locking mechanism comprises a locking device, which may be a mechanical shaft constructed with a screw head 355, at one end and a mechanical locking structure 350, at the other. A cut-out 310 in the removable key-holder 300 may be provided into which the locking structure 350 fits.

When the mechanical locking structure 350 is rotated by turning the screw, the mechanical locking structure 350 slots into the cut-out 310, thereby providing a positive mechanical lock. When the screw head 355 is further rotated (or rotated back again), the mechanical locking structure 350 is rotated out of the recess 310 in the removable key-holder 300, thereby allowing the removable key-holder 300 to be removed from the HHC device.

The procedure for replacing and locking the removable key-holder 300 is simply the reverse of this. Once removed or disassembled, the removable key-holder 300 can be rotated as required, replaced to the device and once again locked in place.

Re-configuration of the HHC device 180 between respective landscape modes (210, 230 of FIG. 2) is a two stage process, and is achieved by removing the removable key-holder 300, rotating it through the required angle, in the example of FIG. 3 the angle being 180°, and re-locating it to the HHC device 180. The HHC device 180 is capable of detecting the rotation and of adjusting the image displayed on the display 120 accordingly.

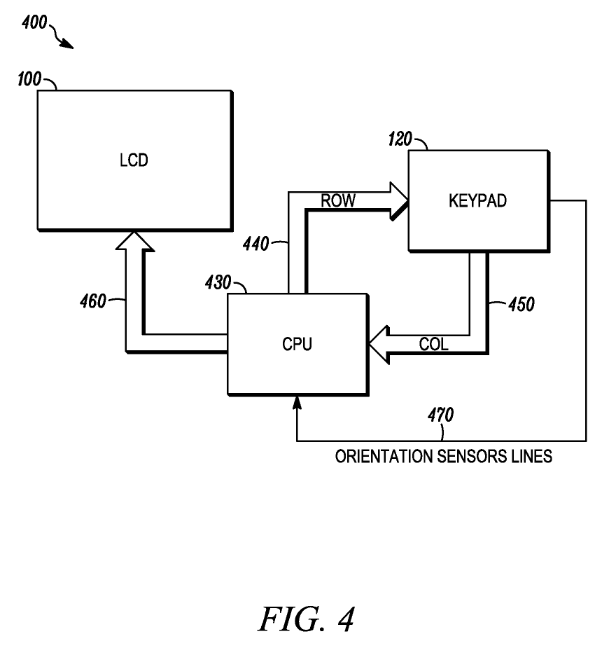

This image adjustment embodiment is achieved by adapting display-driver circuitry, and/or the device firmware that executes on a processing unit of the HHC device, as illustrated schematically in the drawing 400 of FIG. 4. Once physically re-configured, both keypad 120 and display 100, appear to the user to have the same orientation.

In FIG. 4, the display 100 is operably coupled to a CPU 430 via a communication bus 460. The CPU 430 is operably coupled to the keypad 120. The keypad 120 has three interfaces with the CPU 430, all of which are used to carry data to the CPU 430. A key press on the keypad 120 is encoded by detection circuitry (not shown) into, say, a column reference 450 and a row reference 440. The values of the column reference 450 and the row reference 440 co-operate together as an index into the column reference 450 and the row reference 440 corresponds to that of the key that was pressed.

In this manner, a table of values can be arranged to correspond to the physical layout of the keys on the keypad 120. This table of values can be manipulated by the CPU 430 of the HHC device, depending upon the physical orientation of the keypad 120.

Thus, it is possible to ensure that the key-press is always correctly decoded, despite the device having been re-configured. This may be achieved with the provision of a further data interface 470 between keypad 120 and CPU 430. This further data interface 470 may carry information acquired from position or location sensors (not shown), located on the keypad-PCB. For example, in FIG. 3, the position sensors may be activated by downward pressure generated by the mechanical boss 330 of the removable key-holder 300 when the removable key-holder 300 is assembled to the HHC device 180. The activation of a position or location sensor allows the CPU 430 to ascertain an orientation of the keypad 120. In response to this determination, the CPU 430 then adjusts the graphic image appearing on the display 100 to match the detected orientation.

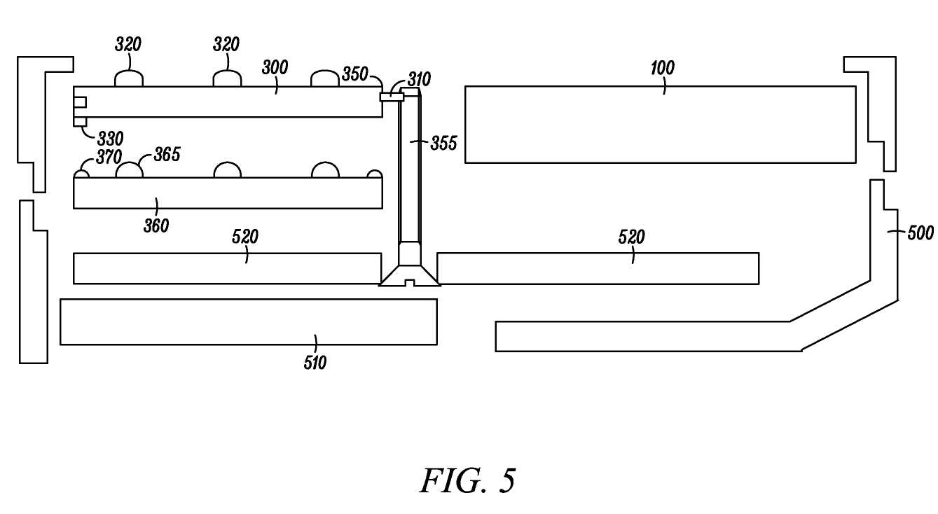

Referring now to FIG. 5, a side elevation of the HHC device is illustrated. The side elevation also illustrates the housing 500, the display 100, the removable key-holder 300, keys 320, the keypad printed circuit board (PCB) 360, a main PCB 520 and a battery 510. Further components 350, 355 also shown in FIG. 5, are part of a locking mechanism that ensures that the keypad 120 remains firmly attached to the HHC device during normal operation.

For clarity, the removable key-holder 300 and the keypad PCB 360 are shown widely separated from each other. However, in practice, they exist in close contact if a key-press on the keypad 120, is to be accurately detected by a sensor 365 located on the key-pad PCB 360.

Disassembling the removable key-holder 320 from the device housing 500 in FIG. 5, would result in the configuration of components shown in FIG. 3, to which we once again refer.

The removable key-holder 300 of the device shown in FIG. 3 is rectangular in shape, and thus has 180° symmetry i.e. once removed from the device 180, it must be rotated through 180 before it may be re-assembled to the device.

In an alternative embodiment, a square removable key-holder has 90° symmetry and could thus be reassembled to the device after a rotation through only 90°.

Referring now to FIG. 1, if a hand held ‘portrait’ device 110, 130, is rotated through 90° and used as a landscape device 230, 210, as illustrated in FIG. 2, the keypad 120 must be rotated, but through −90° with respect to the 180° rotation (flipping) of the HHC device 180, in order to nullify the effects of the +90° rotation of the device. The negative (−) sign indicates that the rotation of the keypad 120 is a counter rotation with respect to the rotation of device. This counter rotation of the keypad 120 can be thought of as cancelling out the rotation of the device that was required in order to transform the user interface from a ‘portrait’ mode to a ‘landscape’ mode.

The same is, of course, true for the reverse transformation from a ‘landscape’ mode to a ‘portrait’ mode.

As previously mentioned, this type of simple physical reconfiguration is possible, when the shape/symmetry of the keypad 120, including the placing of the keys on the keypad 120, allows rotation through 90°. For example, in one embodiment, it is envisaged that the keypad 120 may be an alternative shape/symmetry other than rectangular, for example a square or circular shape, with the layout of the keys 320 and lettering 340 being designed appropriately.

Again referring to FIG. 3, once re-configured, the orientation of the keys 320 and the lettering 340 on the keys 320 always corresponds to the orientation 345 of the display 100. The keypad-PCB 360 may be, however, fixed mechanically to the device 180. Thus, a key-press detection/decoding mechanism may comprise a key 320, a corresponding metal domed key-press sensor 365 arranged to detect a key-press activation, the keypad-PCB 360, and device firmware running on the CPU 430. In this manner, the key-press detection/decoding mechanism re-configures its operation such that a key press may be correctly decoded.

In order to achieve this, the CPU 430 may be configured with prior knowledge of, or be able to discover, an orientation of the removable key-holder 300. In one embodiment, as illustrated in FIG. 3, an orientation of the removable key-holder 300 may be determined using an orientation detection system. The orientation detection system may comprise detector 370 and mechanical boss 330 arranged to automatically ascertain a current orientation of the removable key-holder 300, and thereafter decoding any key-press signal accordingly.

The orientation detection system may comprise a number of position or location sensors 370 located on the keypad-PCB 360. In one embodiment, the orientation detection system may comprise at least one mechanical structure, such as a mechanical boss 330, located on the removable key-holder 300 that acts as an actuator for the location sensor 370, as shown in FIG. 3.

It is envisaged that the detection system may make use of any physical phenomenon, such as pressure, magnetism, light (optics), etc. In the embodiment illustrated in FIG. 5, a mechanical boss 330 combined with a metal-dome type pressure sensor 370 is used, because the keypad-PCB 360 already uses this type of sensor in order to detect a key-press. Thus, in this embodiment, the detection system relies on the same technology as the key-press detection system, thereby reducing the HHC device's cost and complexity.

When the removable key-holder 300 is mounted to the HHC device, the mechanical boss 330 presses down onto the metal dome of the position or location sensor, and is detected by the CPU (say CPU 430 in FIG. 4) in much the same way as a key-press would be detected.

In the example illustrated in FIG. 3, the removable key-holder 300 is rectangular in shape and can be mounted to the device in one of two orientations. In this case, only one mechanical boss 330 and two position or location detectors 370 are required, in order to positively determine the orientation of the removable key-holder. A skilled artisan will appreciate that a different number of position or location detectors 370 may be required for different shaped removable key-holders.

The position or location detectors 370 may operate as binary devices, for example they may have only two operating states, ‘on’ and ‘off’, or binary ‘1’ and ‘0’. The two detectors may thus detect four states (0,0) (1,0) (1,1) (0,1), and thereby provide four pieces of information. The (0,0) state may be configured as a useful information state, in that it may inform the CPU that the removable key-holder has not been re-assembled to the device, and that the device is thus not operable.

For HHC devices where multiple orientations are possible, for example with a circular or hexagonal removable key-holder, a more complex detection scheme is required; i.e. one capable of detecting at least as many states, as there are orientations.

In the embodiment of FIG. 3, a single detector 370 would in fact, be sufficient, as rotation of the removable key-holder 300 would cause the state of the signal from the detector 370 to change, implying that the orientation had changed.

If yet more flexibility is required of the HHC device, i.e. if the removable key-holder 300 should also be replaceable and not simply rotatable, then a more sophisticated key-press detection mechanism may be required. This is due to the fact that a new removable key-holder 300 may have an entirely different key layout, with more or less keys 320 than the original removable key-holder, and/or keys located in different physical positions on the removable key-holder 300.

In this case, the design of the HHC device may be modified such that keypad-PCB 360, with its fixed geometry and fixed number of key-press sensors 365, may be replaced with a digitiser (not shown). A digitiser, in this embodiment, encompasses a keypad-PCB device capable of detecting a key-press anywhere on its surface, and not only at specific key-press detection points 365. When a key-press is detected by the digitiser, it may generate an output that corresponds to the physical location of the key-press, for example the X-Y coordinate of the key-press on the active surface of the digitiser.

In this embodiment, the output of the digitiser may then be input to the CPU as before, where the key-press may be decoded by the firmware running on the CPU. This may be achieved by means of a look-up table of ‘X-Y’ coordinates and corresponding key-values, thereby allowing specific key-values to be decoded by reference to their X-Y positions. Thus, various removable key-holders with different key-densities (numbers of keys) and key-orientations can be programmed into the firmware of the HHC device and thereafter detected.

Further subdivisions of ‘landscape’ orientation devices are those of right handed (RH) and left handed (LH) devices. This subdivision is advantageous, as a wearable device may need to be used by a right-handed or a left-handed person. A wearable device constructed to be worn on the left arm 210 (when used by a RH person), may have its display 100 to the left of the keypad 120. This may be implemented so that when the keypad 120 is being used, the user's arm does not restrict the viewing area, by moving into the user's line of sight, and thus masking areas of the display 100 and restricting the viewing area.

As most people are right-handed, most devices are set up for RH operation. A left-handed user must thus re-configure the device 230, such that the display 100 is to the right of the keypad 120. When a device 230, so configured, is worn on the right arm, and the keypad is used by the left hand, then the left arm likewise does not restrict the viewing area.

In order to reverse the relative positions of the display 100 and keypad 120, the RH device 210 must be rotated through 180° resulting in the required LH configuration 230. In order to compensate for this rotation, the keypad 120 must experience a counter rotation of −180°. This is achieved by removing the removable key-holder 300, illustrated in FIG. 3, from the device, rotating it through −180°, and replacing it. The new orientation of the removable key-holder 300 may be detected by the CPU 430 as previously described, and the display 100, and key detection mechanisms adjusted accordingly. In this case, it is possible to use a removable key-holder shape that has 180° symmetry, such as a rectangular keypad.

In one embodiment, the CPU 430 is configured to be aware of the correct orientation of the removable key-holder, in order to prevent false operation of the device. In this embodiment, the modular keypad system is thus conceived with a locking mechanism that may be disengaged before the removable key-holder can be removed from the device. In this embodiment, the locking mechanism comprises a locking device 355, which may be a mechanical shaft constructed with a screw head at one end, and a mechanical locking structure 350 at the other end. A cut-out 310 in the removable key-holder 300 is provided, into which the locking structure 350 is arranged to fit.

The mechanism by which this is achieved can be more clearly understood by reference to FIG. 5. FIG. 5 illustrates a cross sectional view of a HHC device according to the current invention, showing the removable key-holder 300, keypad-PCB 360 including key-press detector dome-mechanism 365, main PCB 520, battery 510, display 100, housing 500, and mechanical locking device 355.

The locking structure 350 of the mechanical locking device 355 can be seen in FIG. 5 to be located within the cut-out 310 provided in the removable key-holder 300, thus locking the removable key-holder 300 to the HHC device.

In one embodiment of the present invention, it is advantageous for correct operation of the device 180 that the CPU correctly detects an orientation of the removable key-holder 300 after each re-configuration. In order to ensure that this is the case, the HHC device 180, according to one embodiment of the present invention, is designed such that the screw-head of the mechanical locking device 355 is located within the battery compartment, for example behind the batteries 510. In this embodiment, it is necessary to remove the batteries 510 in order to gain access to the screw head of the locking mechanism 355; whereby removing the batteries 510 causes the CPU to be powered down. The mechanical locking mechanism 355 may also be constructed such that the batteries 510 cannot be replaced into the battery compartment whilst the mechanical locking mechanism 355 is unlocked. In this manner, the location of the screw-head of the mechanical locking device 355 prevents the HHC device from being re-started without the removable key-holder 300 first being securely locked.

Once the removable key-holder 300 has been replaced, the mechanical locking mechanism 355 has been engaged, and the batteries 510 replaced, the CPU automatically re-starts and runs through its ‘boot’ process. In one embodiment of the present invention, the ‘boot’ software comprises a removable key-holder orientation detection routine. This embodiment ensures that the CPU 430 always detects any re-orientation of the removable key-holder 300.

It is envisaged that many other mechanisms could be implemented in order to achieve this result. For example, it is envisaged that removal of the removable key-holder 300 may directly cause the power to the CPU 430 to be disconnected. Alternatively, it is envisaged that a further detection circuit may be incorporated that causes an interrupt to be generated, which in turn causes the CPU 430 to re-start.

In this embodiment, CPU 430 reads the output of the orientation sensor(s) 370 activated by the mechanical orientation boss 330. The CPU 430 is then able to determine an orientation of the removable key-holder 300 and, in response thereto, initialise itself accordingly. Once the removable key-holder 300 is re-assembled to the device, the orientation boss 330 presses on the dedicated orientation sensor 370 and is detected. A half rotation of the locking screw 355 then causes the removable key-holder 300 to be locked.

Re-inserting the battery then causes the following actions:
(i) The CPU 430 will search for a pressed orientation sensor 370.
(ii)The removable key-holder orientation may be set, for example in response to the detected specific pressed orientation sensor 370.
(iii) The LCD 100, and other device drivers, may be reconfigured for the re-orientation.

Whilst specific implementations of the present invention have been described, it is clear that one skilled in the art could readily apply further variations and modifications of such implementations within the scope of the accompanying claims.

Thus, a configurable HHC device that can be optimised by the user for use in various orientations, and a modular, lockable keypad mechanism for allowing the reconfiguration of the removable key-holder such that it remains correctly oriented for use, has been described, where one or more of the aforementioned disadvantages with prior art arrangements have been substantially alleviated.

A mechanical locking screw mechanism, for example accessible by removal of a power supply of the HHC device, holds the removable key-holder in place during operation. The mechanical locking mechanism may be released by the user, thus allowing the removal of the removable key-holder part of the modular keypad. The removable key-holder, once removed, can be rotated and re-assembled to the HHC, thereby allowing the HHC to be used in ‘portrait’ orientation or ‘landscape’ orientation. This mechanism also allows a wearable HHC device to be worn on the left or right arm, i.e. operated with the left or right hand, whilst minimising restrictions to the viewing area in both configurations.

It is envisaged that, in one embodiment, a ‘portrait-format’ personal digital assistant (PDA) may be transformed by the teachings of the current invention into a landscape-format data logger device, merely by changing its orientation, and by running a suitable software application on the device.

Furthermore, with the addition of external sensors, such as radio frequency identifier (RFID) or bar code readers, the HHC device can be further transformed for use in a variety of applications. Devices according to embodiments of the present invention, such as those shown schematically in FIG. 1 and FIG. 2, may be used in factory or general industrial settings for collecting ‘field’ data, e.g. data acquired by a user walking around a factory site and storing data directly on the device. The data may be acquired wirelessly, by means of an RFID (Radio Frequency Identification) reader integrated with or attached to the device, or by means of a bar code reader integrated with or attached to the device. The data may also be input manually via the keypad or via a touch display or other I/O interface of the device.

1. A Hand Held Computing device (HHC) comprising:
a keypad construction;
a display; and
a processing function that is operably coupled to both the keypad construction and the display,
wherein the keypad construction is of a modular construction and comprises at least a removable key-holder and a key-press detection mechanism,
wherein the removable key-holder may be de-coupled from the key-press detection mechanism, rotated, and re-coupled to the key-press detection mechanism in a different orientation to enable the keypad construction to be operable in the different orientation.

2. The Hand Held Computing device according to claim 1, which is adapted such that the removable key-holder can be rotated through 90°, or an integral multiple of 90°, with respect to its original orientation.

3. The Hand Held Computing device according to claim 2, including a detector that automatically detects the orientation of the removable key-holder by the processing function.

4. The Hand Held Computing device according to claim 3, which is adapted so that removal of the removable key-holder from the HHC device causes a power supply to the processing function to be disconnected.

5. The Hand Held Computing device according to claim 4, wherein the display is operable, under control of the processing function, to automatically re-configure an orientation of images displayed on the display according to a detected orientation of the removable key-holder.

6. The Hand Held Computing device according to claim 5, including one or more orientation sensors capable of detecting an orientation of the removable key-holder.

7. The Hand Held Computing device according to claim 6 wherein the one or more orientation sensors are provided on the key-press detection mechanism.

8. The Hand Held Computing device according to claim 1, including one or more mechanical locking mechanisms operable to lock the removable key-holder when in the device to the key-press detection mechanism.

9. The Hand Held Computing device according to claim 8, wherein the removable key-holder includes a cut-out adapted to receive a structure of the locking mechanism.

10. The Hand Held Computing device according to claim 8 wherein the removable key-holder is locked to the device by the mechanical locking mechanism.

11. The hand held computing device according to claim 1, wherein the keypad construction comprises a keypad printed circuit board (PCB) and a locking device, the key-holder removable from the keypad PCB and capable of being re-orientated relative to the keypad PCB and replaced in location with the keypad PCB, the removable key-holder being provided with recesses, one or more of which is utilised by the locking device to lock the removable key-holder in place when in use in the computing device.

12. The hand held computing device according to claim 11, wherein the removable key-holder is further provided with a mechanical structure or orientation boss, which, when the keypad construction is assembled, is detected by one or more orientation sensors located on the keypad PCB.
